(19) United States
(12) Patent Application Publication
(10) Pub. No.: US 2005/0287033 A1
(43) Pub. Date: Dec. 29, 2005

(54) Micro flame detector and method for gas chromatography

(75) Inventor: Kevin B. Thurbide, Calgary (CA)

Correspondence Address: THOMPSON LAMBERT;SUITE 703D, CRYSTAL PARK TWO, 2121 CRYSTAL DRIVE, ARLINGTON, VA, 22202, US

(73) Assignee: UNIVERSITY TECHNOLOGIES INTERNATIONAL INC., CALGARY (CA)

(21) Appl. No.: 11/019,107

(22) Filed: Dec. 22, 2004

Related U.S. Application Data
(60) Provisional application No. 60/582,549, filed on Jun. 25, 2004.

(51) Int. Cl. G01N 25/20

(52) U.S. Cl. 422/51

(57) ABSTRACT

A micro counter-current flame detector is provided that is both sensitive for photometric and ionization detection for gas chromatography (GC). In the detector, a stainless steel capillary (0.01″ i.d.) supplying oxygen functions as a burner, which supports a compact flame that burns in a counter-flowing excess of hydrogen. In the “micro Flame Photometric Detector” (μFPD) response mode, the background emission level is reduced by over an order of magnitude compared to previous experiments using a fused silica capillary burner, resulting in greatly improved detection limits. The device can successfully operate as both a selective and universal GC detector. Results indicate that this micro counter-current flame method yields comparable performance to conventional Flame Photometric and Flame Ionization Detectors.

### CROSS-REFERENCE TO RELATED APPLICATIONS

This application claims the benefit under 35 U.S.C. 119(e) of U.S. provisional application no. 60/582,549 filed Jun. 25, 2004.

### BACKGROUND OF THE INVENTION

An area of increasing development in the field of gas chromatography (GC) is instrument miniaturization. Notable examples of such advances include portable field GC units and GC separations achieved on a micro-analytical chip. In conjunction with these efforts, there is also a growing interest in developing sensitive miniaturized detection methods that can be incorporated into micro-analytical devices. A number of such miniaturized or ‘micro’ detection methods have been reported based on a variety of principals including surface acoustic wave transmission, thermal conductivity, and plasma-based optical emission. Although flame-based detectors are prevalent in many conventional GC applications, relatively few have been adapted to micro-analytical formats. Since the latter tend to utilize very small (nL range) channels, this may be partly attributed to difficulties encountered in operating a stable flame within these dimensions. In this regard, however, a very interesting and useful system has been successfully demonstrated. The method employs low gas flows to support a high energy premixed flame (about 3 mm tall×1 mm wide) that can perform atomic emission/hydrocarbon ionization detection on the surface of a micro-analytical chip.

The flame photometric detector (FPD) is a widely used GC sensor for determining sulfur, phosphorus, tin, and other elements in volatile organic compounds based on their chemiluminescence within a low-temperature, hydrogen-rich flame. Very recently, we introduced a novel method of generating a similar flame environment using counter-flowing streams of gas [K. B. Thurbide, B. W. Cooke, W. A. Aue, J. Chromatogr. 1029 (2004) 193.]. This ‘counter-current’ FPD was demonstrated to provide similar sensitivity and response characteristics to that of a conventional FPD when operated in the hydrogen-rich mode. As well, it was also found to yield useful flame ionization detector (FID) signals when operated in the air-rich mode. Most notably, unlike a conventional FPD, this method produced remarkably stable flames at relatively low and high gas flows of varying stoichiometry. In fact, this aspect of the detector was employed in the primary focus of the study, which explored changes in transition metal response as a function of flame size derived from gas flows that differed by several hundred mL/min.

Subsequent to this work (but actually reported earlier) we exploited the great stability of counter-current flames in a new way by using them to create an enclosed hydrogen-rich micro-flame [K. B. Thurbide, C. D. Anderson, Analyst 128 (2003) 616]. The flame was supported on a fused silica capillary by only a few mL/min of gas flow and encompassed a very small volume of 30 nL. As well, it produced qualitatively similar response characteristics toward sulfur and phosphorus-containing analytes as that of a conventional FPD. The method was employed in a novel micro-Flame Photometric Detector (μFPD) which was operated either inside the end of a capillary gas chromatography column (on-column) or within a length of capillary quartz tubing after the separation column (post-column), with each mode displaying similar characteristics.

In general, the dimensions and qualities of the micro counter-current flame indicated that it could be a potentially useful method of producing chemiluminescent molecular emission, similar to a conventional FPD, within small channels and analytical devices of reduced proportions. However, unlike the larger counter-current flame, the primary disadvantage to the micro-flame method was the relatively large detection limits that it produced for sulfur and phosphorus due to an elevated background emission. The spectrum, intensity, and orange appearance of the emission indicated that the fused silica capillary burner was glowing from contact with the flame. Despite efforts to prevent this it was observed under all conditions investigated.

### SUMMARY OF THE INVENTION

Therefore there is disclosed a μFPD device with enhanced response by removing interference from an elevated background emission. A μFPD flame detector is provided with similar performance to a conventional FPD flame, even though the two differ in size by about 3 orders of magnitude. Further, a flame detector is provided with photometric tin response and flame ionization response.

In accordance with a further aspect of this invention, there is provided an improved μFPD response that is obtained by using a metallic capillary burner to support a micro counter-current flame, as for example a stainless steel capillary burner. The μFPD has satisfactory response for many elements such as sulfur, phosphorus, and tin. Additionally, by polarizing the burner, the micro counter-current flame detector produces a satisfactory ionization response toward carbon. The μFPD as discussed herein is convenient for use in chemical weapons detection, sulfur measurements in, for example, oil and gas or pulp and paper, measuring amounts of H₂S or SO₂ in the environment, analyzing pesticides containing sulfur, phosphorus, and other elements, performing general gas analysis for hydrocarbons present, or detecting other elements such as transition metals and main group elements such as selenium, tin, lead, tellurium, and halogens such as chlorine or bromine.

These and other aspects of the invention are described in the detailed description and claimed in the claims.

### BRIEF DESCRIPTION OF THE FIGS.

There will now be described preferred embodiments of the invention by reference to the figures, by way of illustration only, in which:

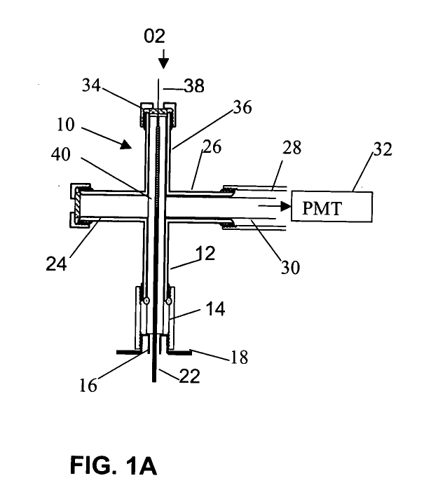

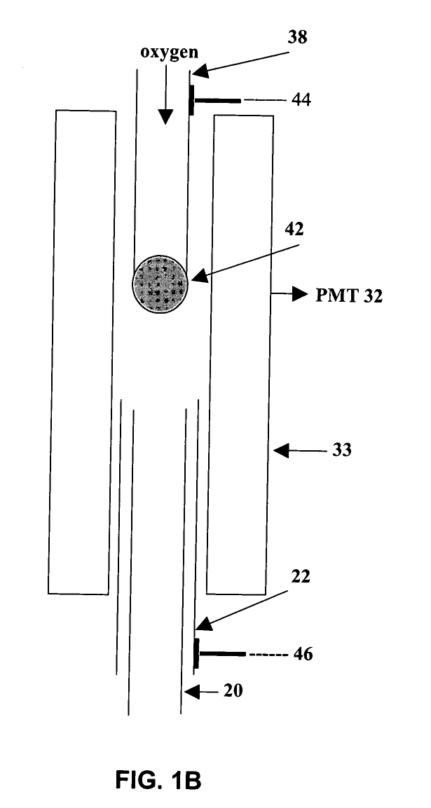

FIG. 1A is a schematic view of a micro-counter-current flame detector according to the invention;

FIG. 1B is a detail of the tip of the burner of FIG. 1A showing a flame;

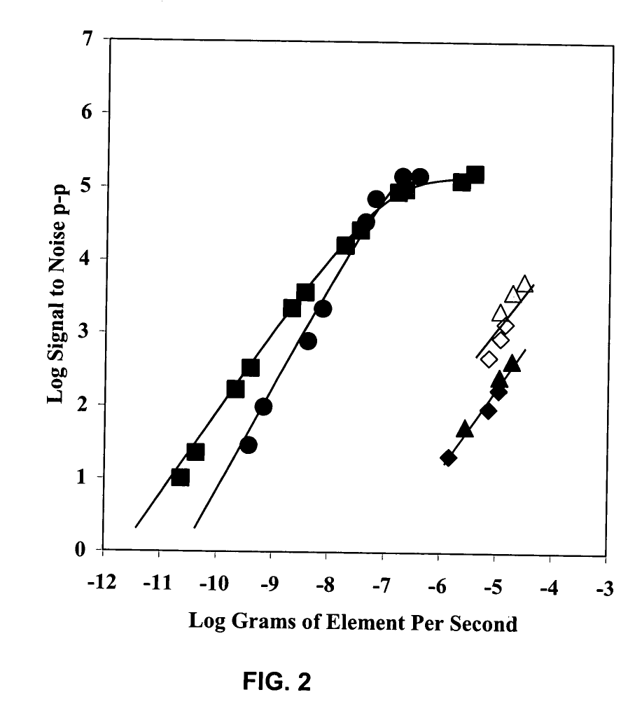

FIG. 2 shows μFPD calibration curves for sulfur as tetrahydrothiophene (●) and phosphorus as trimethyl phosphite (▪) under their respective optimal conditions, as well as the response to carbon as decane (♦) and benzene (▾) is also shown under optimum sulfur (hollow symbols) and phosphorus (filled symbols) conditions (gas flows are listed in the text);.

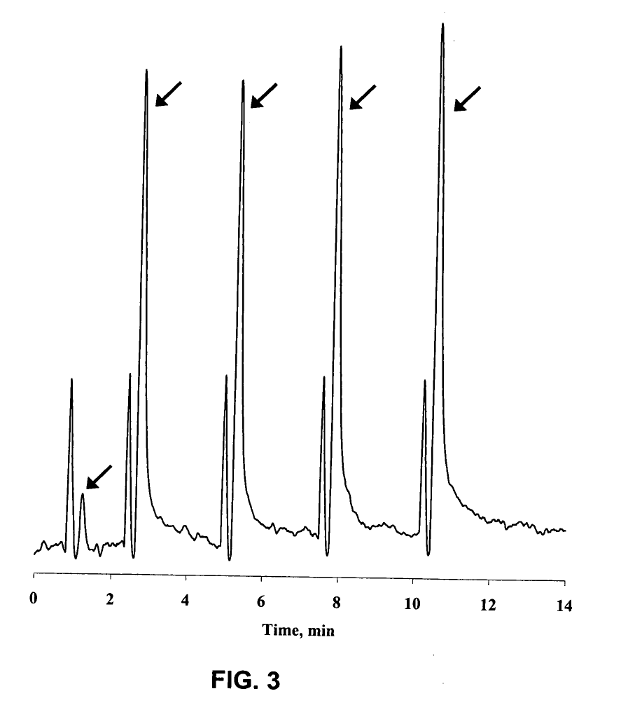

FIG. 3 is a chromatogram illustrating the μFPD response toward tin as tetramethyl tin, where from left to right the amounts injected are 0.1, 1, 10, 100, and 1000 pg respectively, which correspond to the peaks indicated by the arrows;

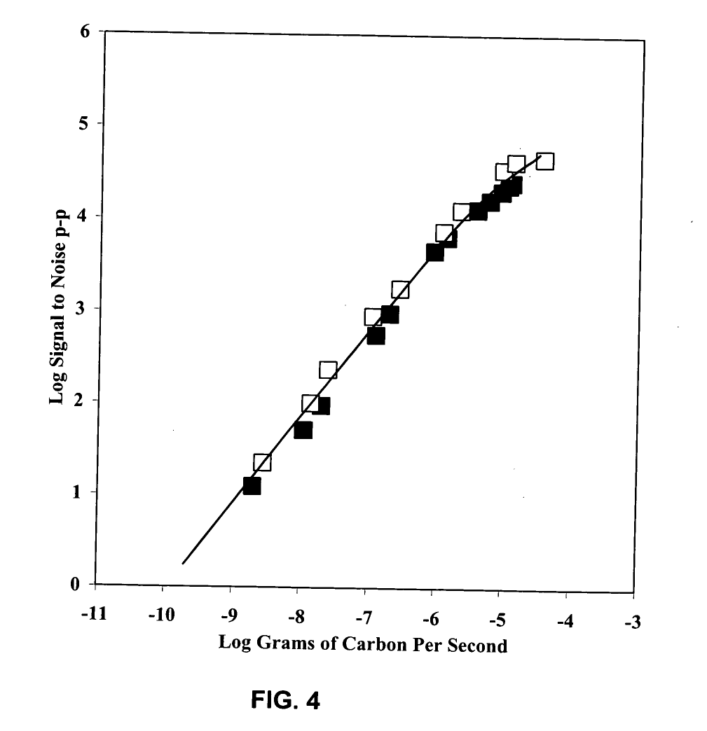

FIG. 4 shows μFID response of the micro counter-current flame toward carbon as decane (▪) and benzene (□), for which the gas flows used are 7 mL/min oxygen and 40 mL/min hydrogen;

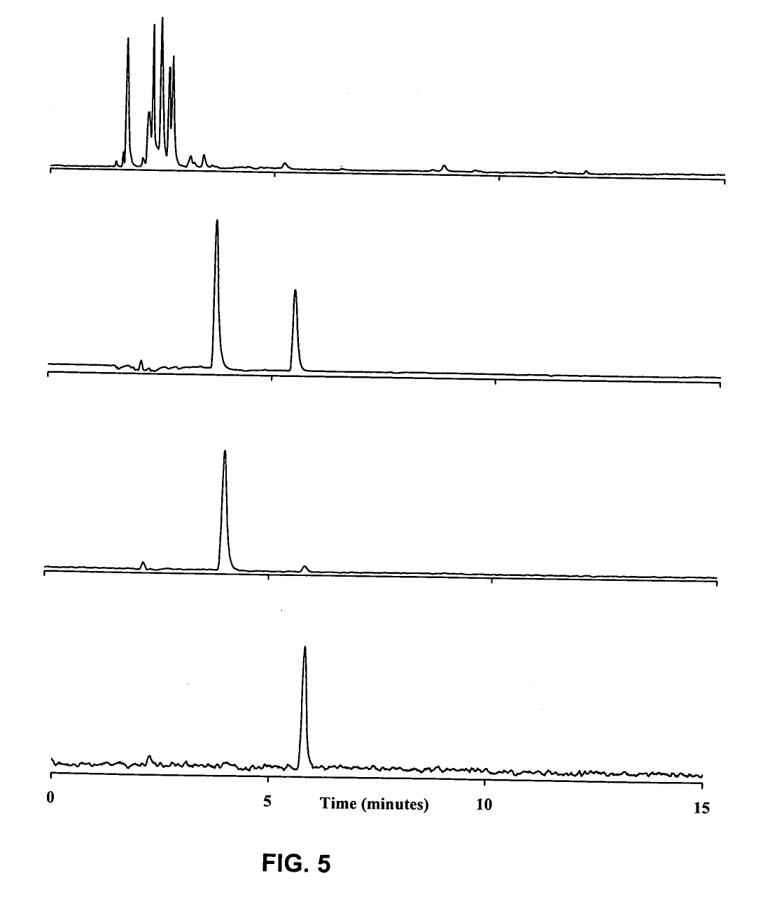

FIG. 5 shows chromatograms of an unleaded gasoline as monitored (from top to bottom) in the μFID mode, the μFPD mode without an interference filter, the μFPD phosphorus mode using a 520 nm (11 nm b.p.) interference filter, and the μFPD sulfur mode using a 393 nm (11 nm b.p.) interference filter (The sample is diluted 1:10 in hexane. Injection volume is 0.5 μL and also contains 500 ng each of tetrahydrothiophene and trimethyl phosphite. The gas flows used are 7 mL/min oxygen and 45 mL/min hydrogen.); and

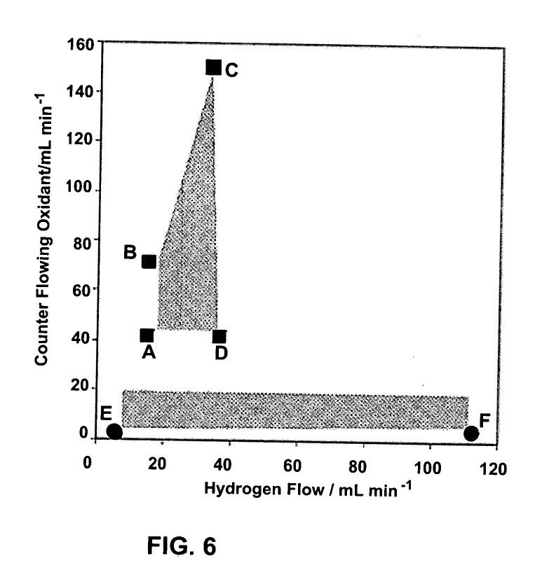

FIG. 6 shows gas flows for a hydrogen/air and a hydrogen/oxygen microflame.

### DETAILED DESCRIPTION OF PREFERRED EMBODIMENTS

In this patent document, the word “comprising” does not exclude other elements being present and the use of the indefinite article “a” before an element does not exclude others of the same element being present. For the purposes of this patent document, including the claims, a flame photometric detector is considered to be a micro-flame photometric detector, or μFPD, if the flame volume is less 1 μL (1×10⁻⁶ L), which for example is satisfied when the flame dimensions are less than 0.1 mm×0.1 mm×0.1 mm.

FIG. 1A presents a simplified schematic illustration of a micro counter-current flame arrangement according to an embodiment of the invention. FIG. 1B shows a detail of the flame region of the μFPD. A housing 10 is conveniently made from a stainless steel ¼″ cross union (Swagelok™) that encloses the micro-flame. The cross design permits monitoring of the flame. The bottom 12 of the housing 10 is connected to a 10 cm length of stainless steel tubing 22 ( 1/16″ o.d.) for the supply of hydrogen to the flame region 40 at the center of the housing 10. The housing 10 is secured via a union adaptor to a tube stub 16 (¼″ o.d.) that fits an FID detector base 18 of a Gas Chromatograph instrument (GC Shimadzu model GC-8A). Hydrogen is introduced from a suitable source (not shown) and suitable ferrules such as Vespel™ ferrules are used to connect the hydrogen supply tubing 22 to, but prevent its direct contact with, the GC instrument or detector housing in order to maintain proper FID operation. A ferrule situated within the tube stub 16 is suitable for securing the tubing 22. One of the horizontal ports, such as port 24, of the housing 10 is used to visually align and monitor the micro-flame. Directly opposite to this, the other horizontal port 26 is adapted with a threaded stainless steel tube 28 that encases a quartz light guide 30 (150 mm×6 mm o.d.) which directs the flame emission to a photomultiplier tube 32 (R 268 with wavelength range 300-650 nm; Hamamatsu, Bridgewater, N.J., USA).

A quartz capillary sleeve 33 (0.9 mm i.d.) extends vertically from bottom port 12 through to top port 36. In the lower port 12, the capillary sleeve 33 surrounds the hydrogen sleeve 22 and a capillary GC column 20. Above the lower port 12, in the flame region 40, the capillary sleeve 33 conducts the hydrogen and column effluent (analyte plus carrier) from capillary sleeve 22 towards the flame 42. Through a septum 34 in the top port 36, a length of stainless steel capillary tubing 38 (0.01″ i.d.×0.018″ o.d.) carrying oxygen extends downward into the quartz sleeve 33 to the center 40 of the union 10, directly in front of both the light guide port 26 and the viewing port 24. Under typical operating conditions, the micro-flame 40 is situated on the end of this oxygen capillary 38 burning ‘upside down’ within a counter flowing stream of hydrogen and column effluent from the bottom. The arrangement for delivering hydrogen and analyte may be varied considerably from what is described here. A tube in tube arrangement with hydrogen in the annulus between the tubes may be used as described here. Also, hydrogen may be supplied through a capillary column 20 along with the analyte. Other arrangements will occur to a person skilled in the art.

The separation column 20 employed is an EC-5 ((5% Phenyl)-95% Methylpolysiloxane) megabore column (30 mm×0.53 mm i.d.; 1.00 μm thickness; Alltech, Deerfield, Ill., U.S.A.) that extends vertically upward from the GC instrument and into the detector housing 10 through the connecting stainless steel tube 22 carrying the hydrogen. Typical separations employ 5 mL/min of helium as the carrier gas. Normally, about 2-3 mm separates the end of the column 20 from the oxygen burner 38. For μFID experiments, electrical leads from a Shimadzu GC are used such that the polarizer 44 of the GC is connected to the stainless steel oxygen burner 38 and the collector 46 is connected to the stainless steel hydrogen tube 22 surrounding the separation column 20.

High purity helium, hydrogen, and oxygen may be obtained from any suitable source such as Praxair. Tetrahydrothiophene (99%), trimethyl phosphite (99%), benzene (99%), decane (99%), and tetramethyl tin (95%) are obtained from any suitable source, such as Aldrich.

Stainless steel is an improvement over fused silica because it has a higher heat capacity. As such, the heat of the flame does not cause it to glow from being incandecently heated. Glowing creates a large background response in the detector, which decreases its sensitivity. The improvement offered by stainless steel include improved detection limits and the simultaneous FID method and allow the method to be useful in more situations. In addition to a stainless steel capillary, the flame could also be supported on other metals that have a sufficiently high melting point, such as nickel, or some alloys. Typical flame volume for the stainless steel example given here was about 30 nL.

The flame 40 is lit by introducing hydrogen, and igniting the flame as a diffusion flame at the top of the chimney. The oxygen containing capillary 38 is then drawn through the flame, ignites, and is pushed into the hydrogen stream, keeping it lit. The original flame either extinguishes or can be blown out like a candle. Once lit, the flame generally stays stable for hours.

Use of pure oxygen is preferred as a supply of oxygen. Experiments with air found that a flame was difficult to establish and prone to extinguish depending on the flame conditions. Therefore, the influence of gas flows on the effective operating region was explored. FIG. 6 displays the operating region of this flame which spans air flows from about 40 to 150 mL min⁻¹ and hydrogen flows from about 15 to 40 mL min⁻¹. It was found that the two major limiting factors controlling the operating region were flame stability and background emission. For relatively low settings of 15 mL min⁻¹ of hydrogen and 42 mL min⁻¹ of air (point A in FIG. 6) the background is visually observed to be relatively low, however, the flame is also relatively unstable and will extinguish frequently. Lower gas flow settings cannot establish a stable flame. For the lower limit of hydrogen flow (15 mL min⁻¹) the stability increases substantially as the air flow is increased to 72 mL min⁻¹ (point B in FIG. 6) however, a relatively very large background emission is observed. For higher flow settings of 37 mL min⁻¹ of hydrogen and 42 mL min⁻¹ of air, flame stability and background emission are found to moderately increase (point D in FIG. 6). At very large flow settings of 34 mL min⁻¹ of hydrogen and 150 mL min⁻¹ of air (point C in FIG. 6) the flame is observed to be very stable with a relatively very large background emission. Thus, overall, using the lowest flame gas flows possible (point A in FIG. 6) yields an opposing trend of a desirable decrease in the flame background emission and an undesirable decrease in the flame stability. This is understandable, given that these gas flows do not differ that greatly from those normally used in a conventional FPD but, when directed through a much smaller burner, the resulting flame becomes unstable and encompasses much of the available volume inside the column around the upper burner. Since the utility of this flame appeared quite limited, further experiments with air were abandoned.

Upon using oxygen in the upper burner a remarkable difference in flame dynamics was observed as the flame rarely extinguished, if at all, once inside of the capillary column 33. FIG. 6 displays, by comparison, the operating region for the hydrogen/oxygen micro-flame. It was found that increasing the oxygen flow toward 20 mL min⁻¹, for all hydrogen flows, causes intense glowing and some deformation of the upper burner 38 and so this region was not explored further. However, as can be seen, this flame can be operated over a much wider range of hydrogen flows with correspondingly much less flow of oxidant gas compared to air. The lower hydrogen limit measured was 6 mL min⁻¹ using 2 mL min⁻¹ of oxygen (point E) while the upper hydrogen limit measured was 113 mL min⁻¹ using 5 mL min⁻¹ of oxygen (point F). In terms of background emission, the hydrogen/oxygen flame shows the same trend as the hydrogen/air flame and, thus, the lowest gas flows that describe point E yield the lowest relative background emission observable. This is also considerably lower than the background emission observed for the lowest hydrogen/air flame gas flow setting. In stark contrast to the hydrogen/air flame, however, the hydrogen/oxygen flame displays excellent stability under all of the conditions tested. This is also noted by its extraordinary capacity to withstand solvent injections tested up to 10 μL. As well, visually it appears much more compact in size and precisely centered in the viewing area. Thus the hydrogen/oxygen micro-flame provides the best properties in terms of stability and background emission, and the optimal flow region for operation is found to be in the area of 6 mL min⁻¹ of hydrogen and 2 mL min⁻¹ of oxygen. It should be noted that this flow region did not display any signs of flame instability and was typically operated daily for over 8 h with no degradation in performance. Lower gas flows than 6 mL min⁻¹ of hydrogen and 2 mL min⁻¹ of oxygen are also believed to be provide flame stability.

Burner Characteristics

Stainless steel capillary tubing of both 0.01″ i.d. and 0.005″ i.d. was investigated for its properties as a μFPD burner 38. Respectively, these dimensions are the same as and smaller than the fused silica tubing i.d. used previously. It was found that both tubing sizes were able to support a stable flame. However, the 0.005″ i.d. (0.009″ o.d.) tubing was observed to glow considerably, yielding a similar background emission to that noted earlier for the fused silica burner. In terms of relative wall thickness, this capillary burner (0.002″) was slightly smaller compared to the fused silica tubing (0.003″) used originally.

In contrast to this, when trials were run using the 0.01″ i.d. (0.018″ o.d.) tubing as a burner 38, the orange glow was observed to disappear and the background emission was much less intense compared to that obtained with fused silica. This tubing has a wall thickness of 0.004″. It therefore seems advantageous to have a wall thickness greater than 0.002″ (0.05 mm) under typical conditions in order to avoid any glowing of the stainless steel burner. In routine comparisons with fused silica burners, it was found that the thicker walled stainless steel capillary tubing readily reduced the background emission observed by over an order of magnitude. Also in general, the size, stability, chemiluminescent properties, and gas flow operating regions of the flame itself did not differ between stainless steel and fused silica burners of 0.01″ i.d. under the same conditions. Therefore, this stainless steel capillary tubing provides a more effective burner for the μFPD and was used in experiments described herein.

Photometric Response of Sulfur and Phosphorus

Similar to earlier efforts using a fused silica burner, the best μFPD signal to noise ratios in this study are also generally found at lower flows of oxygen and hydrogen, the former having a much more significant impact on the background emission. Using stainless steel the optimum μFPD response for sulfur was obtained with 7 mL/min of oxygen and 45 mL/min of hydrogen, while that for phosphorus was obtained when using 9 mL/min of oxygen and 58 mL/min of hydrogen. While these oxygen flows agree within 3 to 5 mL/min of those used in the ‘post-column’ detection mode of the previous μFPD experiments, the hydrogen flows used are 30 to 40 mL/min smaller [27]. However, as demonstrated in that study, the latter is directly proportional to the inner diameter of the quartz capillary sleeve used. Since the sleeve used currently is narrower by comparison, smaller optimum hydrogen flows are to be expected.

As a result of the diminished background emission obtained using stainless steel, the signal to noise ratios realized for sulfur and phosphorus are about 100 times larger than those reported earlier for the μFPD. FIG. 2 demonstrates this with the μFPD response toward increasing amounts of sulfur and phosphorus test analytes under their respective optimum conditions. As can be seen the quadratic response toward sulfur (as tetrahydrothiophene) spans over 3.5 orders of magnitude down to a minimum detectable limit of 3×10⁻¹¹ gS/s. This value is determined at the conventional signal to noise ratio of 2, where noise is measured as the peak to peak fluctuations of the baseline over at least 10 analyte peak base widths. For phosphorus (as trimethyl phosphite) the μFPD response is linear over 5 orders of magnitude down to a minimum detectable elemental flow of 3×10⁻¹² gP/s. Overall, these values are greatly improved compared to the initial μFPD study using a fused silica capillary burner. In fact, similar to the larger counter-current flame, they now agree very well (within a factor of 2) to those produced by the much larger flame of a conventional FPD.

FIG. 2 also includes the response toward different flows of carbon (as both decane and benzene) obtained under optimal sulfur and phosphorus conditions in the μFPD. As can be seen, the sensitivity between benzene and decane differs very little in each mode. While this is reasonable, it is necessary to examine since it has been demonstrated previously that aromatic compounds can respond considerably stronger than aliphatic compounds under certain FPD conditions. As a result of the different optimal gas flows used, the carbon response displayed in FIG. 2 increases by a factor of 6 from the phosphorus to the sulfur mode. Therefore, phosphorus in the μFPD yields a molar selectivity over carbon (i.e. mole P/mole C that yield the same response within the linear range) of 5 orders of magnitude. Conversely, owing to its quadratic response, sulfur produces a molar selectivity over carbon of 3.5 orders of magnitude near the upper response limit, which narrows as analyte amounts decrease. These values, obtained in the ‘open’ mode without any wavelength discrimination, are also improved relative to the earlier μFPD study. Further, they resemble those reported for a conventional FPD such as reported by M. Dressler, in Selective Gas Chromatographic Detectors (Journal of Chromatography Library, Vol. 36), Elsevier, Amsterdam, 1986, p. 133 and the larger counter-current flame.

Narrow band interference filters are often used to selectively monitor sulfur or phosphorus response in the conventional FPD, although this practice is known to decrease sensitivity. Since these methods were equally effective in the μFPD with a fused silica capillary burner, no differences in behavior of the narrow band interference filters were anticipated or observed from using stainless steel instead. For example, when the S₂* emission of sulfur is isolated and monitored near 400 nm, the μFPD sensitivity for this element typically decreases by a factor of 2 to 10 times depending on the filter used. Comparable results are also obtained when observing the HPO* emission of phosphorus near 526 nm. Selective monitoring of sulfur and phosphorus using suitable interference filters with the μFPD is demonstrated later in this study.

Another concern that arises for monitoring sulfur using an FPD is the quenching of analyte signal that occurs in the presence co-eluting hydrocarbons [C. G. Flinn, W. A. Aue, Can. J. Spectrosc. 25 (1980) 141 and Dressler cited above]. While this phenomenon is widely observed in conventional FPD detection, it is unknown to what extent that it may occur in the counter current flame of the micro-FPD. Since very similar chemiluminescent systems, such as the reactive flow detector do not demonstrate this phenomenon, it is therefore useful to examine if response quenching by co-eluting hydrocarbons is observed in the micro-FPD. In order to investigate this, a sulfur peak was measured with and without a co-eluting solvent peak present. Table 2 displays the results and clearly indicates that as the amount of co-eluting acetone approaches 1 μL, the sulfur response reduces to approximately 30% of that which occurred without any acetone present. This amount of acetone corresponds to about 60 μg s⁻¹ of carbon flow in the detector, which agrees with the mass flow of carbon observed to induce sulfur response quenching in a conventional FPD. Thus, similar to a conventional FPD, sulfur response quenching due to co-eluting hydrocarbons does occur in the micro-FPD and this effect appears to only be significant for carbon flows in the microgram range.

The setup used also helps avoid false positives and avoids carbon influencing the results. The simultaneous FID mode helps to identify large amounts of material as opposed to strongly responding sulfur or phosphorus compounds.

Photometric Response of Tin

Tin is another element commonly monitored by a conventional FPD, normally producing a red and/or blue chemiluminescence in the detector. Thus far, tin response has not been examined in the μFPD or in the larger counter-current flame. However, during the course of this study, quartz sleeves contaminated with traces of tin were visually observed to yield an intense blue emission on the surface of the enclosure surrounding the flame. This same luminescence is also observed in the form of tailing peaks when picogram quantities of tetramethyl tin are introduced into the detector equipped with a regular clean quartz capillary sleeve. This is consistent with the emission of SnO* on a quartz surface, which is well known to yield a very sensitive response toward tin compounds in a conventional FPD. Incidentally, the much less sensitive red emission in the gas phase (ascribed to SnH*) was not observed here. Therefore, considering its intensity, the blue tin emission was further examined in the μFPD.

Optimum signal to noise ratios for tin were obtained using 10 mL/min of oxygen and 25 mL/min of hydrogen. These μFPD conditions provide sensitive response yielding a detection limit near 6×10⁻¹⁵ gSn/s. However, increasing amounts of tin were only found to linearly increase the response over an order of magnitude. For instance, with tetramethyl tin this is observed between approximately 0.1 and 1 pg of the injected compound. This narrow linear range also reproduces with other calibration standards such as tetrabutyl tin, and under a variety of gas flows investigated. FIG. 3 illustrates this for a 0.1, 1, 10, 100, and 1000 picogram injection of tetramethyl tin under the same optimal μFPD condition. As can be seen for the larger amounts, even though the mass of analyte increases 1000 times, very similar signals are produced. Additionally, while peak heights do not appreciably increase for this mass range, it is observed occasionally that the peak widths sometimes do. These factors are indicative of detector saturation near the upper limit of response, which has been noted for nanogram quantities of tin compounds in conventional FPD studies [Flinn]. Since tin emission in the μFPD stems from the quartz surface of the enclosure, attempts were made to increase the available surface area by using a larger diameter tube and packing quartz wool into the detector cell. While these alterations have shown positive effects on tin response in a conventional FPD, they were not effective in the μFPD. It should be noted, however, that less peak tailing was observed when using the larger tubing. Thus, the μFPD appears capable of yielding quartz surface emission that is sensitive toward picogram quantities of tin compounds. However, it is unclear why the detector currently displays saturation at such low analyte levels. Regardless, until further improvements can be realized, the narrow linear range of tin response offered by the μFPD makes it impractical as a tool for routine organo-tin analysis.

Ionization Response

By using a stainless steel capillary burner in the μFPD, it has been demonstrated that the micro counter-current flame yields chemiluminescent response that is very similar to that found in much larger conventional or counter-current FPD flames. Earlier, it was also briefly noted that the larger counter-current flame was observed to provide highly sensitive FID response toward an aliphatic and an aromatic test analyte. However, more comprehensive aspects such as the relative sensitivity toward these analytes or the linearity of these responses were not investigated in the primarily photometric study. Since the micro counter-current flame provides photometric response that is similar to its larger analogue, it was somewhat anticipated that it too might also deliver useful ionization response toward carbon. However, the fuel-rich hydrogen radical flame chemistry that supports photometric signals is unique from the air-rich oxygen radical flame chemistry that promotes hydrocarbon ionization. Since the effect of reducing counter-current flame size on these processes remains unclear, it is therefore necessary to establish and investigate the extent of FID response that can be derived from the μFPD flame. This information is also potentially beneficial since such a feature could be useful in applications where both universal and selective detection of samples is desired.

Fortunately, this is facilitated by using a stainless steel capillary burner 38 in the μFPD, which makes it very convenient to apply a potential across the flame. Using the existing FID electrical leads of the GC, this mode of response was examined by applying the polarizer 44 to the capillary burner 38 and the collector 46 to the stainless steel sleeve 22 surrounding the end of the separation column. An arrangement of leads with a polarized flame burner situated below the collector of a conventional FID is known from H. H. Hill, D. G. McMinn, in Detectors for Capillary Chromatography; eds. D. G. McMinn, H. H. Hill; John Wiley, New York, 1992, 7. While other variations such as reversing the polarizer and collector connections were explored, these were not found to yield as favorable a response.

Several gas flows were examined for their impact on the ionization response of the flame. Initially, when the capillary burner was new, about 12 mL/min of oxygen was found to provide the best sensitivity. However, after a few hours of conditioning, this value decreased and stabilized at lower flows. Ultimately, the optimum gas flows for the “μFID” response mode of this flame toward carbon were obtained using 7 mL/min of oxygen and 40 mL/min of hydrogen. It is interesting to note that this flame stoichiometry is considerably rich in hydrogen compared to that of a conventional FID, which commonly yields optimal response when operated under leaner oxygen-rich conditions [Hill]. However, the flames used in the two devices are significantly different, particularly with respect to their structure.

For instance, the FID flame normally operates in a diffusion mode where hydrogen and column effluent are introduced through a central burner supporting the flame, which is concentrically surrounded by an excess of oxygen [Hill]. In contrast to this, the μFID flame operates in the unique counter-current mode, where it is supported on a capillary delivering oxygen, and burns in a counter-flowing excess of hydrogen mixed with column effluent. In this fashion the analyte, immersed in hydrogen, is directed toward the counter-current flame's oxygen-rich inner cone through its hydrogen-rich outer mantle. This is opposed to the conventional FID where analytes, also immersed in hydrogen, enter the oxygen-rich outer mantle of the flame through its hydrogen-rich inner cone region.

Considering these structural differences then, they could possibly play an important role in the strong ionization response observed in the fuel-rich μFID flame. For example, if more effective mixing were to occur in the micro counter-current flame, despite its richer stoichiometry, it might still efficiently produce oxygenated carbon species such as CHO similar to the air-rich diffusion flame of a conventional FID. Note that this species is believed in the art to be responsible for the sensitive signal of the FID, even though it is only produced by about 1 in 10⁶ carbon atoms. Unfortunately, the actual extent of mixing in these two detectors, or their relative yields of flame species such as CHO is not presently established. However, it is interesting to point out that the above scenario is consistent with earlier reports of strong FID sensitivity being obtained from a premixed, fuel-rich, hydrogen/oxygen flame, and an even more turbulent oscillating FID flame.

FIG. 4 demonstrates the μFID sensitivity toward carbon as both decane and benzene under optimum conditions. As can be seen, the response of the two compounds agrees within a factor of 2, and increases linearly over 5 orders of magnitude yielding a detection limit of 2×10⁻¹⁰ gC/s. In terms of absolute sensitivity, under typical operating conditions the μFID produces a response of about 5 milliCoulombs/gC. The same values were also obtained from carbon measurements performed with the original GC-FID instrument adapted for use in these experiments. Further, they agree within a factor of 10 to those reported in the literature for a fully optimized commercial FID [Hill]. It should be noted that the larger counter-current flame was earlier observed to provide a greater FID sensitivity than that found in this study. However, the optimal flame conditions established were air-rich, similar to a conventional FID. This is opposed to the optimal hydrogen-rich flame conditions realized currently. Although leaner, oxygen-rich operating ranges were explored in the μFID, it was found that the resulting flames were less stable and more difficult to manage under the conditions examined. Nonetheless, the performance of the prototype μFID still compares well to a conventional FID, especially considering that it is obtained from a relatively simple apparatus. As such, better response may still be possible upon continued optimization of the flame, burner, and detector housing design.

Previously the larger counter-current flame was found to provide optimal ionization and optimal photometric response using respective air flows that were similar and hydrogen flows that differed by about 2 to 5 times. In this way the detector appeared flexible for dual channel operation. However, since FID response was not primarily examined in that study, the effect on sensitivity of changing the gas flow settings was not investigated. What is interesting about the optimum hydrogen-rich gas flows for ionization response in the current study, is that they are now much closer to those employed for optimal photometric response than was the case for the larger counter-current flame. Thus, it should be possible to utilize a common set of conditions that would provide both optimal, or near optimal μFPD and μFID response. This would be very useful in allowing the simultaneous screening of samples by both detection modes since conventionally one derives optimal response using an entirely different flame stoichiometry than the other. Therefore, it would be useful to know how the μFPD sensitivity for sulfur and for phosphorus may be influenced by changing the gas flows between the various optimum μFPD and μFID settings.

Table 1 illustrates the relative change in the μFPD sulfur signal when using gas flows optimized for obtaining photometric sulfur, photometric phosphorus, and hydrocarbon ionization response from the flame. Also included is a similar set of data illustrating the relative change in the μFPD phosphorus signal in each of these three operating modes. As can be seen from the table, the μFPD sensitivity for sulfur and for phosphorus changes relatively little amongst the different settings. The sulfur signal is decreased by only 4% when operated in the photometric phosphorus mode, and by 10% when operated in the hydrocarbon ionization mode. By comparison, the phosphorus signal is decreased by 15% when operated in the photometric sulfur mode. Furthermore, under μFID optimized conditions where the largest change is observed, the μFPD phosphorus signal still maintains about 70% of its optimal sensitivity.

Sample Analysis

Given that significant ionization and chemiluminescent signals can both be obtained from the same micro counter-current flame, detector performance was studied when analyzing an organic sample matrix. In order to demonstrate this, a quantity of unleaded gasoline (purchased from a local vendor) was spiked with both tetrahydrothiophene and trimethyl phosphite prior to analysis. Since gasoline typically contains a moderate variety of hydrocarbon compounds, this simple sample provides a good illustration of the detector's ability to screen a multi-component mixture for its carbon, sulfur, and phosphorus content.

FIG. 5 displays the chromatographic profile of the gasoline sample as monitored (from top to bottom) by the μFID response toward carbon, the μFPD response without an interference filter, the μFPD response toward phosphorus at 520 nm, and the μFPD response toward sulfur at 393 nm. These were performed under a common set of conditions (i.e. those of optimal μFPD sulfur response) chosen to yield the best possible sensitivity within all three detection modes. Incidentally, under these conditions, the μFID response was found to be least compromised and maintained 90% of its optimal sensitivity. As observed in the figure, the μFID trace shows several partially separated peaks illustrating the primary hydrocarbon components of the sample, while in the μFPD trace below only those peaks containing sulfur and phosphorus are dominant. It should be mentioned that while other sulfur or phosphorus peaks may have been present amongst the main hydrocarbon components of the sample, it is possible that quenching of their μFPD emissions may have occurred. For instance, emission quenching by co-eluting hydrocarbons is widely observed in the conventional FPD [Dressler]. Similarly, it has also been shown to reduce μFPD response by nearly 70% when carbon flows of 60 μg/s or greater are present in the detector [K. B. Thurbide, C. D. Anderson, Analyst 128 (2003) 616].

FIG. 5 also demonstrates the μFPD traces which selectivity monitor the HPO* emission of phosphorus, and the S₂* emission of sulfur at specific wavelengths using an appropriate interference filter. Note that the peak for trimethyl phosphite appears somewhat sharper than in the earlier work, which was performed ‘on-column’ at lower temperatures when using hydrogen as the carrier gas [Thurbide 2003]. Similar to previous studies, the phosphorus trace additionally yields a minor contribution from sulfur due to the well-known extension of S₂* emission bands above 500 nm. Thus, FIG. 5 shows that information qualitatively similar to a conventional FID and a conventional FPD can also be obtained in two dimensions from the same micro counter-current flame.

In all, the attributes of this method demonstrate that the hydrogen-rich micro counter-current flame is indeed capable of delivering useful, sensitive response toward organic analytes. In spite of its very small size, it yields selective chemiluminescent and universal hydrocarbon ionization response that is similar in quantity and quality to those of conventional flame based detectors. As well, since it can deliver this as a multi-dimensional response under a common set of conditions, the micro counter-current flame method allows for more information to be obtained from a sample analysis. The properties and dimensions of the micro counter-current flame may therefore be potentially useful for application to analytical devices of reduced proportions. For instance, since the method can support a stable hydrogen-rich micro-flame within a small channel, it may be beneficial for portable or miniature GC methods where the performance of a conventional FPD and/or FID in an enclosed micro format is desirable. The apparatus and method disclosed here should also act as a useful flame source to support and adapt other micro-flame based detection methods such as Alkali Flame Detection. The apparatus and method disclosed also have utility in refinery and hydrocarbon processing plants for example in online applications.

TABLE 1
Effect of Different Operating Modes on μFPD Sensitivity

| | Operating Mode^{a} | | |
|---|---|---|---|
| | μFPD (S) | μFPD (P) | μFID (C) |
| Sulfur | 1.00 | 0.96 | 0.90 |
| Phosphorus | 0.85 | 1.00 | 0.72 |

^{a}Each mode is optimized for the element shown in brackets. Conditions are listed in the text.

TABLE 2
Sulfur response^{a} in the micro-FPD with and without
co-eluting^{b} solvent present solvent

| Solvent | Original sulfur |
|---|---|
| Injected/μL | Signal (%) |
| 0.0 | 100 |
| 0.2 | 99 |
| 0.5 | 96 |
| 1.0 | 33 |

^{a}Injected as ethyl sulfide; monitored using a 400 nm wide band colored glass filter (100 nm bandpass).
^{b}Peak separation is 10 s.

Immaterial modifications may be made to the embodiment of the invention described here without departing from the invention.

1. A micro-flame photometric detector, comprising:
a housing having a flame detection port, an oxygen inlet, a hydrogen inlet, an analyte port and a flame region;
a metal capillary for delivering oxygen through the oxygen inlet to the flame region, the metal capillary having a melting point sufficiently high that glow emissions from the metal capillary during flame detection does not significantly interfere with detection, the metal capillary providing a flame stabilization surface for a flame less than 1 μL in volume;
a hydrogen and analyte delivery system for delivering hydrogen and analyte to the flame region; and
a photo-detector arranged to detect flame emission through the flame detection port.

2. The micro-flame photometric detector of claim 1 in which the metal capillary is a stainless steel capillary.

3. The micro-flame photometric detector in which the oxygen inlet and the hydrogen inlet are arranged to provide counter-current flows of oxygen and hydrogen.

4. The micro-flame photometric detector of claim 1 in which the hydrogen inlet is provided through the analyte port.

5. The micro-flame photometric detector of claim 1 in which the housing forms a cross.

6. The micro-flame photometric detector of claim 2 in which the stainless steel capillary has a wall thickness of greater than 0.05 mm.

7. The micro-flame photometric detector of claim 1 configured as a flame ionization detector with a polarizer connected to the metal capillary and a collector connected to the hydrogen and analyte delivery system.

8. A method of detecting an analyte using a micro-flame photometric detector, the method comprising the steps of:
stabilizing a flame on the end of a metal capillary arranged for delivering oxygen to a flame region of the micro-flame photometric detector in the presence of hydrogen, the metal capillary having a melting point sufficiently high that glow emissions from the metal capillary during flame detection does not significantly interfere with detection, the flame having a volume less than 1 μL; and
detecting the flame emission through a port of the micro-flame photometric detector.

9. The method of claim 8 in which the metal capillary is a stainless steel capillary.

10. The method of claim 9 used as a flame ionization detector with a polarizer connected to the metal capillary and a collector connected to a hydrogen and analyte delivery system.

11. The method of claim 8 in which the analyte is one of sulphur, phosphorus, tin and carbon.

12. The method of claim 8 in which the flame is created at the confluence of counter-current flows of hydrogen and oxygen.

13. The method of claim 12 in which hydrogen is supplied to the flame region at a gas flow rate of about 6 mL min⁻¹ and oxygen is supplied to the flame region at a gas flow rate of about 2 mL min⁻¹.

14. The method of claim 12 in which hydrogen is provided in stoichiometric excess of oxygen.

15. The method of claim 12 in which hydrogen is supplied to the flame region at a gas flow rate of between about 6 mL min⁻¹ and 113 mL min⁻¹ and oxygen is supplied to the flame region at a gas flow rate of between about 2 mL min⁻¹ and 5 mL min⁻¹.

16. The method of claim 8 used as a flame ionization detector with a polarizer connected to the metal capillary and a collector connected to a hydrogen and analyte delivery system.

17. The method of claim 16 applied to the detection of analyte in a flow of hydrocarbons.
